(19) United States
(12) Patent Application Publication
(10) Pub. No.: US 2003/0063698 A1
(43) Pub. Date: Apr. 3, 2003

(54) Optical synchronous coding system

(76) Inventors: Andrew Bonthron, (US); Richard Nottenburg, (US); Vladimir V. Katzman, (US)

Correspondence Address: FISH & RICHARDSON, PC, 4350 LA JOLLA VILLAGE DRIVE, SUITE 500, SAN DIEGO, CA, 92122, US

(21) Appl. No.: 10/060,901

(22) Filed: Jan. 29, 2002

Related U.S. Application Data
(63) Continuation-in-part of application No. 09/967,853, filed on Sep. 28, 2001.

(51) Int. Cl. H04L 25/34; H04L 25/49; H04L 7/02

(52) U.S. Cl. 375/359; 375/291

(57) ABSTRACT

A synchronous encoder with an output that is limited by the propagation delay of only a single component. The encoder signal, which is initially NRZ, is first aligned with the clock data, then converted to RZ, using a synchronized signal part. Then, it is converted from RZ to NRZ-M, and the output is retimed. The signal can be used to drive an optical modulator for the purpose of generating an optical RZ output.

### CROSS-REFERENCE TO RELATED APPLICATIONS

This is a continuation in part of Ser. No. 09/967,853, filed Sep. 28, 2001.

### BACKGROUND

Optical communications systems often operate by transmitting data through long spans of optical fibers. Coded electrical data may be used to drive an electro-optic modulator in order to produce an optical data stream. Many of these systems optically multiplex a number of different wavelengths on a fiber, each wavelength carrying specific serial data. The optical system often does not transmit a separate system clock. Without such a system clock, the optical system relies on the timing transmitted in serial data streams in order to preserve the system timing.

Information is often transmitted in the data format referred to as optical return to zero or ORZ. ORZ may be generated using two optical modulators, one of which is driven by the NRZ data stream, and the other of which is driven by a system clock that is synchronous to the NRZ data stream. The data stream gates the pulses, such that when the data input from the NRZ data stream is a “1”, then the optical pulse is allowed to pass undisturbed. When the data input is a “0”, then the optical pulse is extinguished. The output of the coder is therefore a synchronous, ORZ encoded data stream which preserves the system clock information in its timing.

Other forms of optical modulation may also be used. In general, differential encoders may be used. A signal that is a non return to zero signal or NRZ signal is a coded signal in which the 1's are represented by one condition of the signal (e.g., optical signal is on), and the 0's are represented by another condition of the signal (e.g., the optical signal is extinguished). Different flavors of the NRZ format exist. The NRZ-mark or NRZ-M signal is one in which the signal changes its condition each time that a 1 occurs, but does not change its condition when a 0 occurs. This signal is highly synchronous, and may conserve bandwidth in the channel. Another system that may be used is duobinary, in which a “0” is represented by a zero level, and a “1” is represented by a positive level if the number of “0”s since the last bit is even, or negative if the number of “0”s is odd.

U.S. Pat. No. 5,625,722 teaches a system for forming encoded RZ pulses. This system, however, attempts to operate without true synchronization, and therefore may cause race conditions and duty cycle distortion in the output signal. Moreover, during a series of data “1”s, the encoder and system acts as a well-known free-running ring oscillator. See the book Monolithic Phase Locked Loops and Clock Recovery Circuit, B. Razavi, IEEE Press, 1996. As known, this may generate its own timing with large phase noise. Therefore, use of this encoder for systems employing the Synchronous Optical Network (SONET) standard, or any other type of synchronous system protocols, could cause significant errors and violate the requirements of the standard.

An implementation of an encoder for carrying out NRZ-M encoding may use a delay element in a feedback loop. An example is shown in FIG. 1. In the FIG. 1 device, the input signal 100 is coupled to one input of an exclusive or gate 110. The output 115 of the exclusive or gate 110 is fed back to the input of the exclusive or gate via a D type flip-flop 120. The D input of the flip flop is driven by the output 115 of the XOR gate 110. The input clock also clocks the D flip-flop clock input 122.

The output 115 of the exclusive or gate therefore drives the flip-flop and is fed back again as in the second input 126 to the exclusive or gate. Effectively, the signal 126 is a copy of 115, that is retimed by clock 122.

When there is no transition during a clock cycle, the two signals applied to the inputs of the exclusive or gate 110 are the same, and the output therefore is zero. When there is a transition during the clock cycle, the signals at the input to the exclusive or gate are different than one another. This means that a transition in signals has occurred within the clock cycle. Therefore, the output of the exclusive or gate toggles, causing a change in the output signal.

### SUMMARY

The present application describes a system which synchronously generates a coded output data stream in a way which is only dependent on the delay of a single element, with minimum if any feedback, and with minimum phase jitter.

### BRIEF DESCRIPTION OF THE DRAWINGS

These and other aspects will now be described in detail with reference to the accompanying drawings, wherein:

FIG. 1 shows a prior art NRZ-M encoder;

FIGS. 2A and 2B show a block diagram of an encoder of an embodiment;

FIGS. 3A-3H show timing diagrams of the FIG. 2 encoder;

FIG. 4 shows a synchronous system using the encoder of FIG. 2;

FIG. 5 shows a data preprocessor used in the FIG. 4 system;

FIG. 6 shows an alternative data preprocessor;

FIG. 7 shows yet another alternative of the data preprocessor.

### DETAILED DESCRIPTION

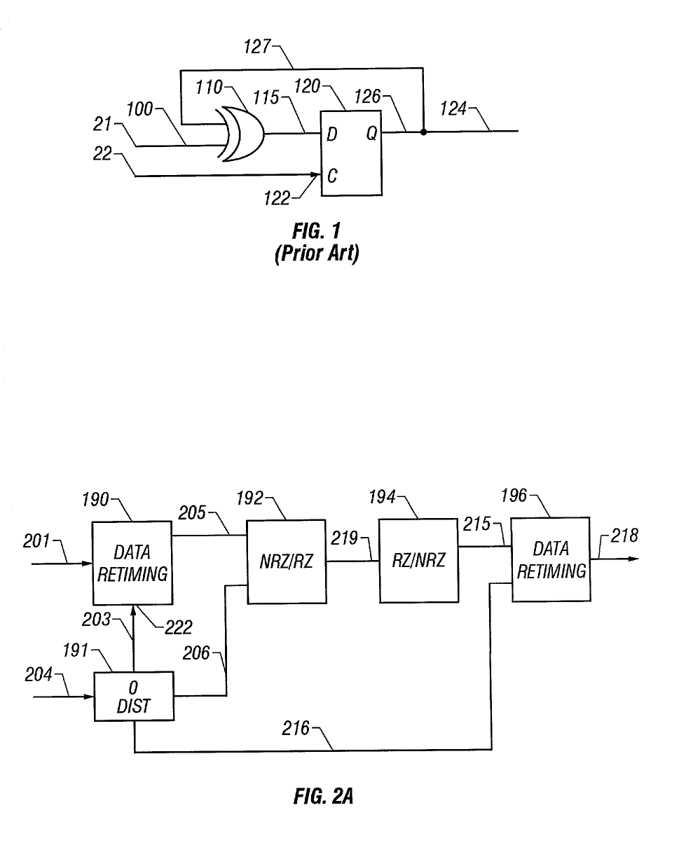

The present inventors recognize that the speed of operation of synchronous circuits such as FIG. 1 may be limited by the feedback loop and the way that the feedback loop inherently limits the speed at which the circuit can operate. For example, the speed of operation of the encoder shown in FIG. 1 is limited by a value related to the sum of the propagation delay of the exclusive or gate 110, propagation delay of the D flip-flop 120, and the delay caused in the transmission lines 126, 127 and 115.

Any transitions that occur faster than this sum may be missed by the system. For example, if there is a signal transition that is faster then the propagation delay sum noted above, then the system might not change state based on that signal transition.

Hence, the maximum frequency of operation can be expressed as:

F_{MAX}=1/(T_{XOR}+T_{DFF}+T₁₂₆+T₁₂₇+T₁₂₈)

where T_{XOR}+T_{DFF}+T₁₂₆+T₁₂₇+T₁₂₈ are the times of propagation within the respective components.

An embodiment is disclosed which avoids or minimizes the speed limitation from the feedback loop and produces a synchronous coded NRZ-M output stream from an input NRZ data stream. This system as disclosed herein may eliminate or minimize the speed limitations noted above, which are caused by propagation delay in the feedback decision loop. The system disclosed herein may be limited by propagation delay only of any single component. The clock and data are aligned at multiple locations in this system, to synchronize the decoder output as constant over process, temperature variations.

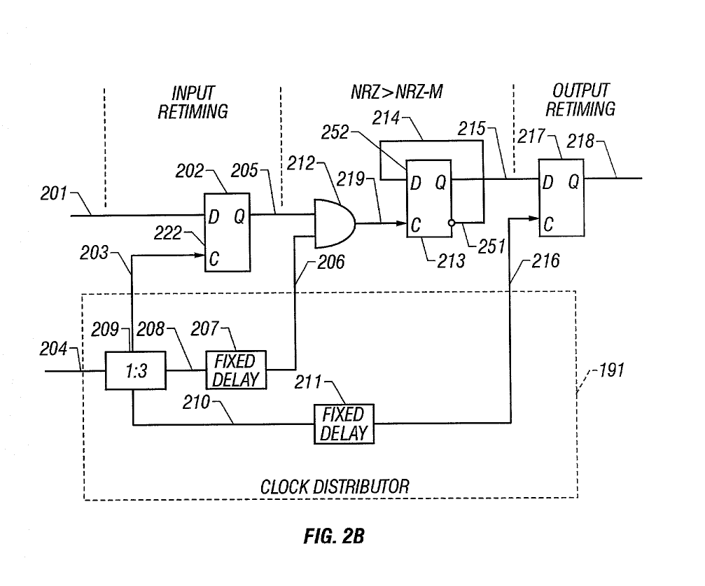

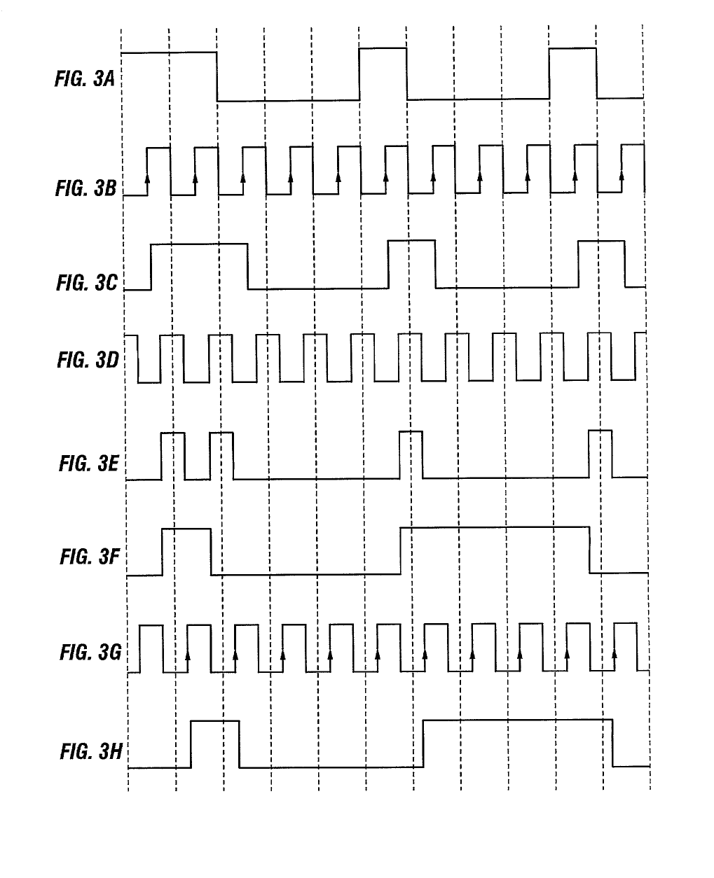

An embodiment is shown in FIG. 2A and 2B, with a timing diagram of the embodiment being described with reference to FIGS. 3A-3H.

The clock signal 204 is split in three paths. The first clock 203 is precisely aligned with data 201 to align data and clock for optimal retiming. The second clock is delayed by delay line 301 to optimize NRZ to RZ conversion. The third clock is used to retime encoded NRZ data from the output of RZ to NRZ converter 196 in order to minimize output jitter and delay time distortion.

In an embodiment, the delay lines may be set to desired amounts of phase shift, e.g., 10° or 1π of phase shift. In this, or other ways, the delayed replicas of the clock may be phase aligned to the input clock.

The block diagram is shown in FIG. 2A with the more detailed block diagram shown in FIG. 2B.

The signal 201 is input into a data retiming circuit 190 which resynchronizes the data to the clock signal.

FIG. 3A represents the input NRZ signal 201 which is applied to the D input of a synchronized latch, here D type flip-flop 202. The system clock for the system is shown in FIG. 3B, represented as input 204. The clock and data may be received from a multiplexer of the conventional type.

204 is input to a splitter 209 which produces three copies of the clock. The splitter may be, for example, a series of resistors arranged in a star shaped arrangement. This maintains the clock versions in phase with one another.

The clock version 203 represents an un-delayed version of the clock, aligned in time with data signal 201.

This clock is used in an input retiming circuit 202 that produces output data that is phase-aligned to the input clock. The clock, here version 203 of the clock, is applied to the clocking input 222 of D type flip-flop 202. The clock synchronously rewrites the data at the D input of the flip-flop 202. This adjusts the phase of the data to substantially perfectly match the phase of the clock, hence rendering the output data 205 synchronous to the clock, as shown in FIG. 3C.

Two more clock replicas are formed for delay compensation, as described later herein. A first delayed clock replica 208 is delayed by a fixed delay element 207 to produce an output clock value 206. The delay element 207 may be formed, for example, by a length of transmission line. This delayed clock is shown in FIG. 3D. This delayed clock is out of sync with the original clock, however the amount of synchronization is fixed.

An AND gate 212 receives the retimed output 205, and the delayed clock 206. A logical AND is carried out between the data signal 205 (shown in FIG. 3C) and the first delayed clock 206 (shown in FIG. 3D). This converts from the first format, here the non return to zero format, to a second format, here the return to zero format. This hence produces an RZ signal as 219, also shown in FIG. 3E. The formation of the different parts of the signal will have minimal “glitches”, but may have “jitter” introduced by speed limitations and other imperfections of the AND gate 212.

The RZ signal 219 is applied to a toggling flip-flop 213, operating in divide by two mode. The flip-flop has an inverting output 251 which is connected to its D input 252 via connection 214. This means that the output 215 (FIG. 2F) changes state each time it receives a rising edge clock signal on its clock input 219. On each rising edge of the RZ signal 219, therefore, the D flip-flop output signal 215 (FIG. 2F) will alternate state; either from a mark to a space, or from a space to a mark.

Since the RZ signal 219 will include a jitter component, the output signal 215 will also include a corresponding jitter component. This jitter component is compensated by a final jitter removal/output retiming circuit 196.

A second delayed clock replica 216 is also formed from the output of splitter 209. This second delayed clock replica is delayed by a fixed delay element 211 to produce an output clock value 216 which is synchronized to the original clock but delayed in phase therefrom by the amount of the fixed delay 211.

The output is retimed by applying the NRZ signal 215 to the D input of an additional D flip-flop 217. This D flip-flop 217 is driven by the delayed clock signal 216 (FIG. 3G). The second delayed clock signal is used to rewrite the signal 215 at the output 218 as shown in FIG. 3H. This properly aligns the clock 216 to avoid jitter and glitches which can lead to duty cycle distortion.

An important feature is that the system continually feeds forward, rather than feeding back. This means that total speed of the system is limited by the speed of propagation delay through a single D flip-flop stage, rather than being limited by a feedback loop. Hence the FIG. 2 circuit may operate much faster than corresponding circuits in the prior art, such as the one shown in FIG. 1. For example, comparing this to the prior art system shown in FIG. 1, the maximum frequency of operation of this system is limited to

F_{MAX}=1/(T_{DFF}+T₂₁₄)

In addition, special synchronization techniques including input signal retiming and realignment 190, interstage delay compensation 207 and 211, and output retiming 196 may improve the signal fidelity at the increased data rates and compensate for process and temperature variations. The output synchronization is thereby maintained.

This compares with the prior art system of FIG. 1 which may require precise alignment of the input data and clock over temperature and time to present special signals to the exclusive or gate 110 that are precisely aligned. Without this precise alignment, the exclusive or gate 110 may produce glitches, duty cycle distortion, and jitter on the output signal, thereby degrading the signal fidelity.

The elements described above may be used as part of a circuit to form synchronous optical coded pulses. An embodiment is disclosed herein which carries out synchronous optical NRZ transmission using a single optical modulator. The optical modulator can be any conventional optical modulator device, such as a Mach Zehnder interferometer, or a directional coupler. The techniques disclosed herein can form an optical modulator which can be single ended or differential drive operation. This system may have the advantage of preserving system timing and signal fidelity over various conditions of operation, including temperature and process.

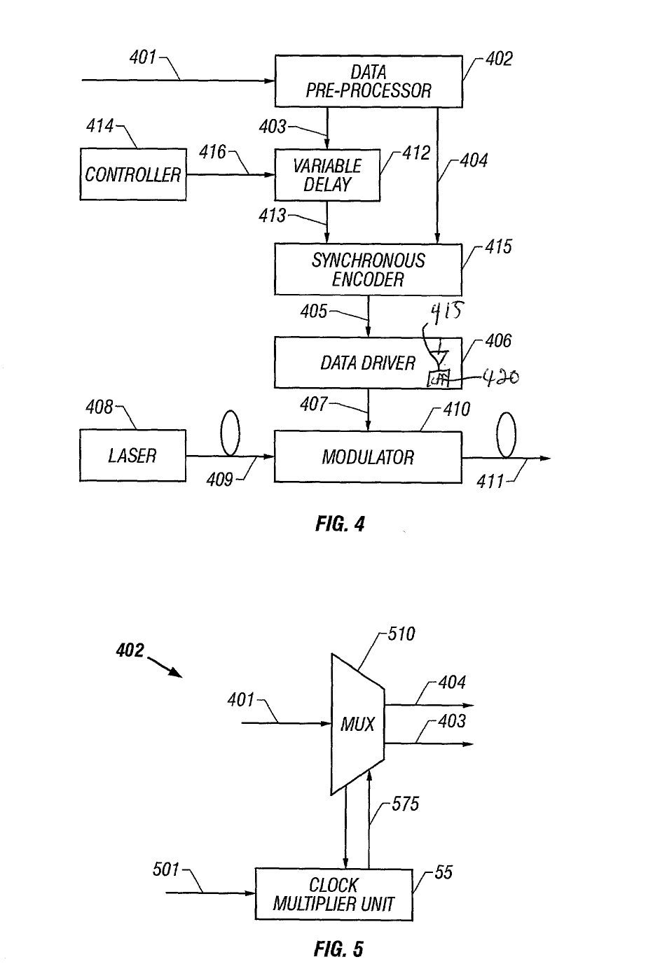

FIG. 4 shows a block diagram of the system. A general n bit parallel NRZ data bus 401 forms the input. The input is coupled to a data preprocessor 402. The data preprocessor 402 may generate an output serial differentially coded data stream 404 and an output synchronous high-speed data clock 403 using conventional techniques. These conventional techniques may include clock recovery and other conventional operations as shown herein with respect to FIGS. 5-7.

The recovered clock 403 is coupled to a variable delay element 412 which may vary the clock phase according to information 416 received from a controller 414. This may be useful, since it may be used to ensure synchronous encoding at very high speed. For example, at high speed, the controller output 4 16 may be used to control precisely the clock distribution.

The varied phase clock 413 is used along with the recovered data 404 to drive a synchronous encoder 415, e.g. of the type described above with respect to FIGS. 2A, 2B and 3A-3H. The controller 414 produces an output that optimally aligns the clock input 413 to the serial data 404. A synchronous encoder 415 then outputs differentially encoded data stream that has both the proper bit coding and the proper synchronization time encoding as 405.

The output 405 is input to a data driver 406 that may drive the coded data stream to produce an output signal 407 having the proper amplitude to properly drive the optical modulator 410. In an embodiment, the data driver may carry out coding for differential NRZ-M code, duobinary code, or any other type of encoding. For duo binary encoding, the data driver may simply be an amplifier 415 followed by a low pass filter 420 having a cutoff frequency that is less than half of the data rate. This provides an output signal that is effectively duobinary encoded.

In this way, the output signal 407 represents final shaped data that drives the optical modulator 410 between its optical output minimum and its optical output maximum, between a mark and a space in the data code.

The modulator 410 is placed in series with a laser 408, e.g., a continuous wave (“CW”) laser, via a transmission line 409. The output 411 of the modulator has the correct differential coding corresponding to the coded data stream 401 further coded with the synchronous timing from the recovered clock 403.

The data preprocessor may have the general form shown in FIG. 5. The NRZ data stream 401 forms the input to the preprocessor circuit. This includes an n bit data bus and may include an optional system clock 501. An electrical multiplexer 510 is combined with the system clock 515 to generate a serial NRZ streaming output 404 along with the multiplied clock 403. The multiplied clock 403 may be a low jitter, high speed clock.

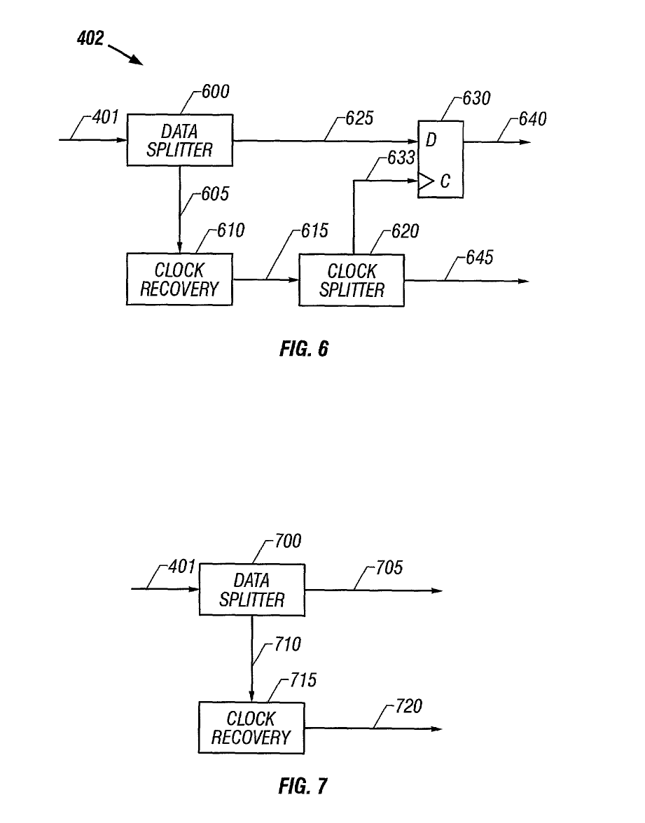

An alternative embodiment of the data preprocessor 402 is shown in FIG. 6. In this embodiment, the input data 401 is first applied to a data splitter 600 which splits the data into two paths. One of the paths 605 is input to a clock recovery circuit 610 that extracts and outputs a high-speed synchronous clock 615. The clock recovered as clock 615 is coupled to a clock splitter 620.

The other arm of data 625 is connected to the input of the D flip-flop 630. The D flip-flop is clocked by a first arm 635 from the clock splitter 620. This carries out the function of retiming the serial data to match the recovered clock. The output data 640 is therefore precisely synchronized with the other clock output 645.

Another embodiment of a data preprocessor is shown in FIG. 7. This data preprocessor operates using the serial data input 401, but does not retime the data. In this embodiment, the data 401 is split by a splitter 700 to produce output data 705. The split data 710 is received by a clock recovery circuit 715, to produce the output low jitter clock 720.

Although only a few embodiments have been disclosed in detail above, other modifications are possible. For example, while the above has disclosed certain circuitry for carrying out the various functions, it should be understood that other circuitry could alternately be used for those functions.

All such modifications are intended to be encompassed within the following claims, in which:

What is claimed is:

1. An encoder, comprising:
a first element receiving input data and producing output data and an associated clock from said input data;
a variable delay line, associated with said associated clock, and a controller, associated with said variable delay line, said controller controlling said variable delay line to produce output signals which are synchronized with said clock; and
a data driver, which converts said output signals into a specified differentially coded form.

2. An encoder as in claim 1, wherein said specified differentially coded form is duobinary coded.

3. An encoder as in claim 2, wherein said data driver includes an amplifier and a low pass filter, filtering an output of said amplifier to a cutoff frequency that is less than one-half of the maximum data rate.

4. An encoder as in claim 2, further comprising a synchronous encoder which encodes said output signals and said clock.

5. An encoder as in claim 2, wherein said specified differentially coded form includes NRZ coding.

6. An encoder as in claim 4, wherein said synchronous encoder converts said input data to a return to zero format; and includes a toggle element, receiving said return to zero data, and changing output state each time said return to zero data is received, to form an NRZ-M data, said toggle element formed of a single functional component.

7. An encoder as in claim 6, wherein said synchronous encoder further comprises a data retiming circuit, receiving said input data and retiming said input data to phase synchronize with said clock.

8. An encoder as in claim 6, wherein said synchronous encoder further comprises a clock splitter, producing a plurality of clock replicas, one of said clock replicas being coupled to said input retiming circuit.

9. An encoder as in claim 8, further comprising an output retiming circuit, receiving said differentially coded data and a first of said clock replicas, and re timing said NRZ-M data according to said first clock replica.

10. An encoder as in claim 8, wherein said clock splitter includes at least one delay element, delaying said clock by specified amounts of time to produce said clock replicas.

11. An encoder as in claim 6, wherein said toggle element comprises a single flip-flop arranged as a toggle.

12. An encoder as in claim 6, wherein said synchronous encoder further comprises at least one retiming circuit operating to reduce duty cycle distortion and jitter in a final signal.

13. An encoder as in claim 6, further comprising a first retiming circuit, operating to synchronize the return to zero signal with one of said clock replicas, and a second retiming circuit operating to synchronize the signal with another of said clock replicas.

14. An encoder as in claim 6, further comprising a clock replica formation circuit, producing first and second delayed versions of the clock as a replica, a first input retiming circuit, using said first delayed version of the clock to retime said input data, and a second output retiming circuit, using said second delayed version of the clock to retime said output.

15. A method, comprising:
receiving data from a source;
processing said data to recover a clock therefrom;
synchronizing said data and said clock using a variable delay element; and
coding said data and clock into a specified differential form.

16. A method as in claim 15, wherein said coding comprises coding into duobinary form.

17. A method as in claim 16, wherein said coding comprises amplifying said signal followed by low pass filtering said signal with a cutoff frequency of less than one-half the data rate.

18. A method as in claim 15, wherein said coding comprises converting to NRZ format.
